(19) United States
(12) Patent Application Publication
(10) Pub. No.: US 2021/0004358 A1
(43) Pub. Date: Jan. 7, 2021

(54) SYSTEM AND METHOD FOR ANALYSIS OF ONE OR MORE STRUCTURED DATA

(71) Applicant: Gangadharan Vijayalakshmi, Chennai (IN)

(72) Inventors: Gangadharan Vijayalakshmi, Chennai (IN); Neelameghan Muralidharan, Chennai (IN)

(21) Appl. No.: 16/685,668

(22) Filed: Nov. 15, 2019

(30) Foreign Application Priority Data
Jul. 5, 2019 (IN) 201941027038

(51) Int. Cl. G06F 16/21; G06F 16/25; G06F 16/28

(52) U.S. Cl. CPC G06F 16/212; G06F 16/28; G06F 16/258

(57) ABSTRACT

A system for analysis of one or more structured data is disclosed. The system includes a data processing subsystem. The data processing subsystem includes a data retrieving module, configured to retrieve one or more structured data of a plurality of file format, The data processing subsystem includes a data analysing module, configured to deduce the one or more structured data of the plurality of file format, configured to analyse the one or more structured data of the plurality of file format by an analysing technique, and also configured to convert the one or more structured data of the plurality of file format after analysis to an executable structured data output in real time. The data processing subsystem includes a data exception handling module, configured to identify data exceptions related the executable structured data output, and also configured to handle data exceptions related the executable structured data output.

This Application claims priority from a complete patent application filed in India having Patent Application No. 201941027038, filed on Jul. 5, 2019 and titled “SYSTEM AND METHOD FOR ANALYSIS OF ONE OR MORE STRUCTURED DATA”.

### FIELD OF INVENTION

Embodiments of a present disclosure relates to analysis of large text, image data, and more particularly to a system for analysis of one or more structured data using various analytical techniques.

### BACKGROUND

Structured data refers to data that has been organized into a formatted repository, typically a database. The repository enables effective processing and analysis. Analysis of large and growing structure data is a very important task. The analysis may be according to the domain the data belong, so specific business logic or understanding is required. Organising, exploring and analysing according to business domain an over-whelming amount of data is a very difficult work. As the number of documents increases, learning the meaning of the text corpora becomes difficult; and thereby thus organising according to required domain in minimum time becomes hard.

In one approach, a system uses various algorithm techniques to organise, explore and understand a collection of structured data. The structured data may be combination of various data types. More efficient way would be to identify and dynamically define a plurality of business workflows. Integration of the said plurality of business workflows together according to need is also a very important feature. Further, an effective approach for any system would be to provide exception handling mechanism for all anomalies created during analysis.

Hence, there is a need for an improved system for analysis of one or more structured data and a method to operate the same and therefore address the aforementioned issues.

### BRIEF DESCRIPTION

In accordance with one embodiment of the disclosure, a system for analysis of one or more structured data is disclosed. The system includes a data processing subsystem. The data processing subsystem includes a data retrieving module. The data retrieving module is configured to retrieve one or more structured data of a plurality of file format.

The data processing subsystem also includes a data analysing module. The data analysing module is operatively coupled to the data retrieving module. The data analysing module is configured to deduce the one or more structured data of the plurality of file format. The data analysing module is also configured to analyse the one or more structured data of the plurality of file format by an analysing technique. The data analysing module is also configured to convert the one or more structured data of the plurality of file format after analysis to an executable structured data output in real time.

The data processing subsystem also includes a data exception handling module. The data exception handling module is operatively coupled to the data analysing module. The data exception handling module is configured to identify data exceptions related the executable structured data output. The data exception handling module is also configured to handle data exceptions related the executable structured data output.

A data memory subsystem is operatively coupled to data processing subsystem. The data memory subsystem is configured to store the one or more structured data of the plurality of file format and the corresponding executable structured data output. The data memory subsystem is located on a blockchain platform.

In accordance with one embodiment of the disclosure, a method for analysis of one or more structured data is disclosed. The method includes retrieving one or more structured data of a plurality of file format. The method also includes deducing the one or more structured data of the plurality of tile formats. The method also includes analysing the one or more structured data of the plurality of tile format by an analysing technique.

The method also includes converting the one or more structured data of the plurality of file format after analysis to an executable structured data output in real time. The method also includes identifying data exceptions related the executable structured data output. The method also includes handling the data exceptions related the executable structured data output.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for analysis of one or more structured data in accordance with an embodiment of the present disclosure;

FIG. 2 is a schematic representation of an embodiment representing the system for analysis of one or more structured data of FIG. 1 in accordance of an embodiment of the present disclosure;

FIG. 3 is a block diagram of a computer or a server in accordance with an embodiment of the present disclosure; and

FIG. 4 is a flowchart representing the steps of a method for analysis of one or more structured data in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for analysis of one or more structured data. The system includes a data processing subsystem. The data processing subsystem includes a data retrieving module. The data retrieving module is configured to retrieve one or more structured data of a plurality of file format.

The data processing subsystem also includes a data analysing module. The data analysing module is operatively coupled to the data retrieving module. The data analysing module is configured to deduce the one or more structured data of the plurality of file format. The data analysing module is also configured to analyse the one or more structured data of the plurality of file format by an analysing technique. The data analysing module is also configured to convert the one or more structured data of the plurality of file format after analysis to an executable structured data output in real time.

The data processing subsystem also includes a data exception handling module. The data exception handling module is operatively coupled to the data analysing module. The data exception handling module is configured to identify data exceptions related the executable structured data output. The data exception handling module is also configured to handle data exceptions related the executable structured data output.

A data memory subsystem is operatively coupled to data processing subsystem. The data memory subsystem is configured to store the one or more structured data of the plurality of file format and the corresponding executable structured data output. The data memory subsystem is located on a blockchain platform.

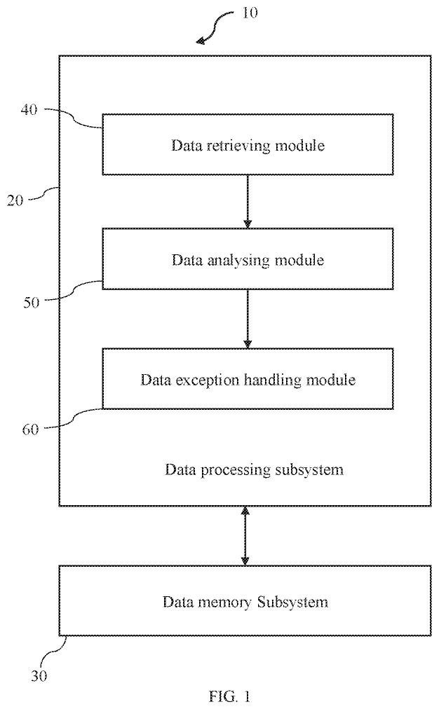

FIG. 1 is a block diagram representation of a system for analysis of one or more structured data 10 in accordance with an embodiment of the present disclosure. As used herein, the term “structured data” is data that has been organized into a formatted repository, typically a database, so that database elements can be made addressable for more effective processing and analysis. As used herein, the term “file format” is a standard way by which information is encoded for storage in a computer file.

The system 10 includes a data processing subsystem 20. The data processing subsystem 20 includes a data retrieving module 40. The data retrieving module 40 is configured to retrieve one or more structured data of a plurality of file format.

In one embodiment, the plurality of file formats may be of domains like related to scientific data, financial records, security and the like. In another embodiment, the plurality of file formats may be of PDF (Portable document format), word document, excel, EDI, proprietary device document and the like. Here, the plurality of file formats may be from any source.

Furthermore, in one exemplary embodiment, the data retrieving module 40 may retrieve two excel documents related to same domain. In such exemplary embodiment, the two excel documents, may contain data related to particular domain in pre-defined model. It may be appreciated by the person skilled in the art, that the files retrieved may be of same format as well as different formats. In another embodiment, the data content defines the application domain workflows. Here, in another specific embodiment, the data retrieving module 40 may retrieve data that may be a device data and a PDF document or a spreadsheets or an app.

The data processing subsystem 20 also includes a data analysing module 50. The data analysing module 50 is operatively coupled to the data retrieving module 40. The data. analysing module 50 is configured to deduce the one or more structured data of the plurality of file format.

The data analysing module 50 is also configured to analyse the one or more structured data of the plurality of file format by an analysing technique. In one embodiment, the analysing technique comprises machine learning technique, artificial intelligence and the like. As used herein, “machine learning technique” refers to an application of artificial intelligence (AI) that provides systems the ability to automatically learn and improve from experience without being explicitly programmed. In one embodiment, the analysing technique applies unique and industry agnostic elastic workflow automation. Here, workflow automation may be through integration of various applications to be an active decision maker of the elastic workflow or deploying any standalone workflow.

The data analysing module 50 is also configured to convert the one or more structured data of the plurality of file format after analysis to an executable structured data output in real time. In one embodiment, the executable structured data output refers to output data which may be used readily in real time with any business domain application.

In continuation of the earlier exemplary embodiment, the analysing techniques such as machine learning technique and subject analysis technique are being used to analyse data present in the two excel document that was retrieved by the data retrieval module 40. Here, the structured data is analysed and presented in proper application domain workflow as executable data output.

The data processing subsystem 20 also includes a data exception handling module 60. The data exception handling module 60 is operatively coupled to the data analysing module 50. The data exception handling module 60 is configured to identify data exceptions related to the executable structured data output. In one embodiment, the data exceptions refer to anomalous or exceptional conditions requiring special processing.

The data exception handling module 60 is also configured to handle data exceptions related the executable structured data output. In one embodiment, the handling of data exceptions may enable by human activities or robotic applications techniques.

It would be appreciated by those skilled in the art, that the handling of data exception by human should be minimized for automation profit. In such embodiment, the robotic applications techniques refer to an application that runs automated tasks scripts over the internet.

Further, the system 10 comprises a data presentation module 70. The data present module 70 is configured to present executable structured output in proper application domain workflow representation. The present executable structured output is stored or archived for further use. (not shown in FIG. 1)

A data memory subsystem 30 is operatively coupled to data processing subsystem 20. The data memory subsystem 30 is configured to store the one or more structured data of the plurality of file format and the corresponding executable structured data output.

In one embodiment, the data memory subsystem 30 is located on a blockchain platform. As used herein, the term “blockchain” refers to a decentralized, distributed and public digital ledger that is used to record transactions across many computers so that any involved record cannot be altered retroactively, without the alteration of all subsequent blocks.

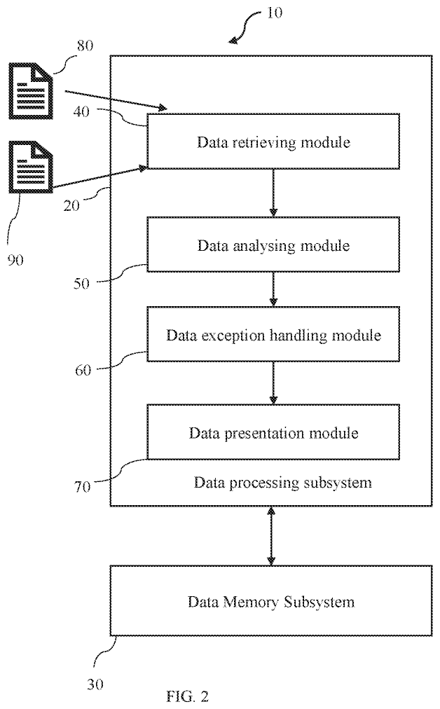

FIG. 2 is a schematic representation of an embodiment representing the system for analysis of one or more structured data 10 of FIG. 1 in accordance of an embodiment of the present disclosure. An exemplary university enterprise resource planning (ERP) system receives two documents 80, 90, basically first document 80 represents an excel sheet containing marks graded for a unit test of a class. The unit test full mark is out of 20.

The second document 90 represents another excel sheet containing marks graded for final exam of the said class. The final test full mark is out of 80. Here, a data retrieval module 40 retrieves two documents. Further, a data analysing module 50, analyses the data of both the documents 80, 90. Here, first the data analysing module 50 deduce the structed data of the unit test 80 and the final test 90.

Lastly, the data analysing module 50 converts the both the data into presentable marks. In such exemplary embodiment, the presentable marks are addition of unit test and final marks, which is out of 100. Here, mathematical analysis of the marks in two excel sheets corresponding to each student is being done for the class. Correspondingly, “pass” and “fail” decisions are being decided for each student by final presentable marks analysis.

In another such exemplary embodiment, if any problem is detected in the marks obtained and final decision, manual interference from humane being may be asked or a robotic application technique may be used. Such exception handling is being done by a data exception handling module 60.

Finally, in the above discussed exemplary embodiment, the final decisions of “pass” and “fail” for each student is being presented by a data presentation module 70.

The data retrieving module 40, the data analysing module 50 and the data exception handling module 60 in FIG. 2 is substantially equivalent to the data retrieving module 40, the data analysing module 50 and the data exception handling module 60 of FIG. 1.

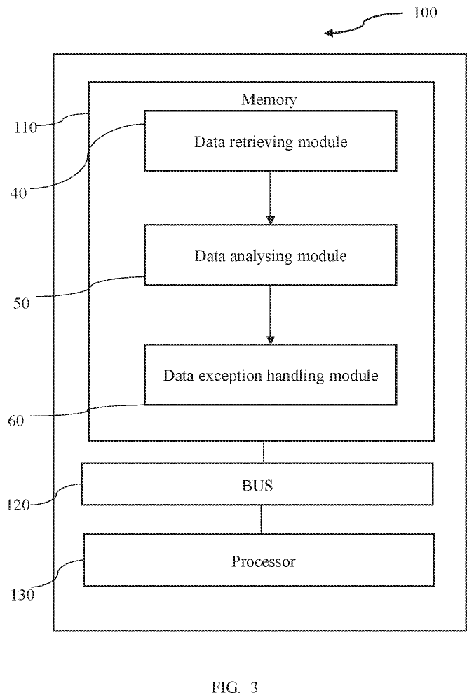

FIG. 3 is a block diagram of a computer or a server 100 in accordance with an embodiment of the present disclosure. The server 100 includes processor(s) 130, and memory 110 coupled to the processors 130.

The processor(s) 130, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 110 includes a plurality of modules stored in the form of executable program which instructs the processor 130 to perform the method steps illustrated in FIG. 1. The memory 110 has following modules: the data retrieving module 40, the data analysing module 50 and the data exception handling module 60. The data retrieving module 40 is configured to retrieve one or more structured data of a plurality of file format.

The data analysing module 50 is configured to deduce the one or more structured data of the plurality of file format. The data analysing module 50 is also configured to analyse the one or more structured data of the plurality of file format by an analysing technique. The data analysing module 50 is also configured to convert the one or more structured data of the plurality of file format after analysis to an executable structured data output in real time,

The data exception handling module 60 is configured to identify data exceptions related the executable structured data output. The data exception handling module 60 is also configured to handle data exceptions related the executable structured data output.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 130.

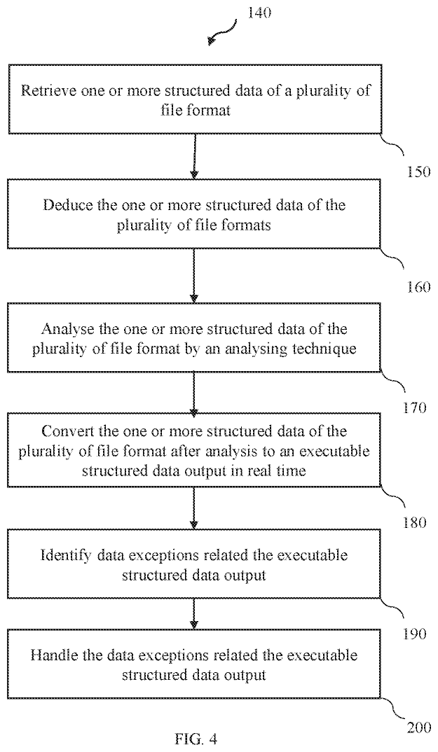

FIG. 4 is a flowchart representing the steps of a method for analysis of one or more structured data 140 in accordance with an embodiment of the present disclosure. The method 140 includes retrieving one or more structured data of a plurality of file format in step 150. In one embodiment, retrieving the one or more structured data of the plurality of file format includes retrieving the one or more structured data of the plurality of file format by a data. retrieving module.

In another embodiment, retrieving the one or more structured data of the plurality of file format includes retrieving the one or more structured data comprising the data corresponding to a plurality of subject domain.

The method 140 also includes deducing the one or more structured data of the plurality of file formats in step 160. In one embodiment, deducing the one or more structured data of the plurality of file formats includes deducing the one or more structured data of the plurality of file formats by a data analysing module.

The method 140 also includes analysing the one or more structured data of the plurality of file format by an analysing technique in step 170. In one embodiment, analysing the one or more structured data of the plurality of file format by an analysing technique includes analysing the one or more structured data of the plurality of file format by t data analysing module.

The method 140 also includes converting the one or more structured data of the plurality of file format after analysis to an executable structured data output in real time in step 180. In one embodiment, converting the one or more structured data of the plurality of file format after analysis to the executable structured data output in real time includes converting the one or more structured data of the plurality of file format after analysis to the executable structured data output in real time by the data analysing module.

The method 140 also includes identifying data exceptions related the executable structured data output in step 190. In one embodiment, identifying the data exceptions related the executable structured data output includes identifying the data exceptions related the executable structured data output by a data exception handling module.

The method 140 also includes handling the data exceptions related the executable structured data output in step 200. In one embodiment, handling the data exceptions related the executable structured data output includes handling the data exceptions related the executable structured data output by the exception handling module.

The method 140 further comprising storing one or more structured data and the corresponding executable structured data output. In one embodiment, storing the one or more structured data and the corresponding executable structured data output includes storing the one or more structured data and the corresponding executable structured data output by a data memory subsystem.

In another embodiment, storing the one or more structured data and the corresponding executable structured data output includes storing the one or more structured data and the corresponding executable structured data output on a blockchain platform.

Present disclosure of a system for analysis of one or more structured data uses various algorithm techniques to organise and explore a collection of data. The disclosed system enables fast organising of data into different business workflow process. Here, business may be related to any domain. Algorithm techniques enables fast indexing of the document according to different business schema.

Here, the efficiency increases as anomalies are handled automatically or with human interactions. The major advantage is to organise structured data present over different file formats.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well he combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system for analysis of one or more structured data, comprising:
a data processing subsystem, comprising:
a data retrieving module configured to retrieve one or more structured data of a plurality of file format;
a data analysing module operatively coupled to the data retrieving module, and configured
deduce the one or more structured data of the plurality of file format;
analyse the one or more structured data of the plurality of file format by an analysing technique;
convert the one or more structured data of the plurality of file format after analysis to an executable structured data output in real time;
a data exception handling module operatively coupled to the data analysing module, and configured
identify data exceptions related the executable structured data output;
handle data exceptions related the executable structured data output; and
a data memory subsystem operatively coupled to data processing subsystem, and configured to store the one or more structured data of the plurality of file format and the corresponding executable structured data output, wherein the data memory subsystem is located on a blockchain platform.

2. The system as claimed in claim 1, wherein the one or more structured data comprises the data corresponding to a plurality of subject domain.

3. A method for analysis of one or more structured data comprising:
retrieving, by a data retrieving module, one or more structured data of a plurality of tile format:
deducing, by a data analysing module, the one or more structured data of the plurality of file formats;
analysing, by the data analysing module, the one or more structured data of the plurality of file format by an analysing technique;
converting, by the data analysing module, the one or more structured data of the plurality of file format after analysis to an executable structured data output in real time;
identifying, by a data exception handling module, data exceptions related the executable structured data output;
handling, by the data exception handling module, the data exceptions related the executable structured data output;

4. The method as claimed in claim 3, wherein retrieving, by the data retrieving module, the one or more structured data comprises the data corresponding to a plurality of subject domain.

5. The method as claimed in claim 3, further comprising storing, by a data memory subsystem, the one or more structured data and the corresponding executable structured data output.

6. The method as claimed in claim 5, further comprising storing the one or more structured data and the corresponding executable structured data output comprises storing on a blockchain platform.
